(19) United States
(12) Patent Application Publication
(10) Pub. No.: US 2009/0139907 A1
(43) Pub. Date: Jun. 4, 2009

(54) WASTE CLASSIFICATION SYSTEM AND METHOD

(76) Inventors: Stephen Allen Hollingsworth, San Marcos, CA (US); Jeffrey Anton Kacirek, Oceanside, CA (US); Isaac Baden Powell, Vista, CA (US); Michael Kevin Beckel, San Marcos, CA (US); Jacquilyn Marie Burns, La Jolla, CA (US); Karlton Devon Prillerman, Winchester, CA (US)

Correspondence Address: MORRISON & FOERSTER LLP, 12531 HIGH BLUFF DRIVE, SUITE 100, SAN DIEGO, CA, 92130-2040, US

(21) Appl. No.: 11/947,703

(22) Filed: Nov. 29, 2007

(51) Int. Cl. B03B 9/00

(52) U.S. Cl. 209/2

(57) ABSTRACT

A waste classification system and method configured to manage information for waste materials is disclosed. The system and method may be configured to receive information pertaining to classification of waste materials. The system and method maintains and accesses a waste classification database based on material safety data sheets (MSDS) utilizing the location of the waste, and returns waste classification data that may include rules and regulations relevant to the location of the waste.

### FIELD OF THE INVENTION

The present invention relates generally to materials handling, and more particularly to a system and method for classifying hazardous materials.

### BACKGROUND OF THE INVENTION

The United States government started regulating certain chemicals (explosives, oxidizers) as early as the 19^{th} Century. In 1966 congress established the Department of Transportation (DOT), which is responsible for hazardous materials transportation. In 1974 congress passed the Hazardous Materials Transportation Act, giving the secretary of transportation the authority to identify and regulate all modes of hazardous materials transportation. In addition to regulations governing the transport of materials, there are rules and policies governing the storage, handling, use and cleanup of various forms of hazardous materials.

For example, federal, state and local rules can dictate how certain materials are stored, how and by whom they can be used, how they are cleaned should a spill occur and how they are transported and how they are disposed. As a result, numerous entities from auto repair facilities, to hardware stores, to factories and plants, and so on, are required to be in compliance with these rules and regulations, and may also have internal requirements as well. Additionally, record keeping and reporting requirements force these entities to follow best practices in dealing with such materials. The regulations are numerous and in many cases have become so stringent and inclusive that training, knowledge and expertise are required for persons to handle or ship hazardous materials safely and within the law.

Accordingly it would be useful for a handler of waste material to have access to material properties, safety data, and rules and regulations governing the specific material. Therefore, there is a need for systems and methods for accumulation, management, and access of such information.

### SUMMARY OF THE INVENTION

A waste classification system and method for managing information for waste materials is disclosed. The system and method may be configured to receive information pertaining to classification of waste materials. The system and method accesses a waste classification database based on product/material information utilizing the location of the product, and returns waste classification data that may include rules and regulations relevant to the location of the waste.

A first embodiment comprises a waste classification system. The system may include a user interface module configured to receive product information pertaining to a product from a user. Additionally, a waste classification database module may be configured to store waste classification information pertaining to various products. Furthermore, an intelligent waste classification module is configured to manage the waste classification database module to obtain complete and non-redundant waste classification data. The intelligent waste classification module determines whether waste classification data for the product has been previously stored in the data base module. A search engine module may also be configured to search the waste classification database module for the waste classification data corresponding to the product. Also, a location information module may be configured to modify the waste classification data based on a location for the waste. The system further provides a graphical user interface (GUI), via a webpage through the Internet. The GUI is configured to prompt the user (e.g., an employee or member of service personnel who is assisting the customer) for information such as login information of a customer and product information.

A second embodiment comprises a method for waste classification. The method comprises receiving product information from a user, and storing the product information into a waste classification database, wherein the waste classification database is intelligently managed to obtain complete and non-redundant waste classification data. The method determines whether waste classification data for the product has been previously stored in the data base module. The method then searches the waste classification database, for waste classification data corresponding to the product.

A third embodiment comprises a method for waste classification. The method comprises receiving information pertaining to at least one product from a customer, and storing the information in a database. The method performs a product classification search based on the information to obtain new classification data, if the product has not been previously classified. However, if the product has been previously classified, the method automatically populates an inventory information list for the customer with the corresponding waste classification data. The method further performs a waste classification by matching the product information to a material safety data sheet, and classifying the inventory by assigning UPC codes or user defined codes.

Further features and advantages of the present disclosure, as well as the structure and operation of various embodiments of the present disclosure, are described in detail below with reference to the accompanying drawings.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments of the disclosure. These drawings are provided to facilitate the reader's understanding of the disclosure and shall not be considered limiting of the breadth, scope, or applicability of the disclosure. It should be noted that for clarity and ease of illustration these drawings are not necessarily made to scale.

FIG. 1 is a block diagram illustrating an exemplary overview of a materials management system.

FIG. 2 is a block diagram illustrating an exemplary process for responding to a material management event.

FIG. 3 is a block diagram illustrating an exemplary overview of a material management network wherein the waste classification system may be implemented in accordance with an embodiment of the present disclosure.

FIG. 4 is an illustration of an exemplary waste classification system according to embodiments of the present disclosure.

FIG. 5 is an illustration of an exemplary flow diagram of a waste classification process according to an embodiment of the present disclosure.

FIG. 6 shows a flow diagram of a waste classification process according to another embodiment of the present disclosure.

### DETAILED DESCRIPTION OF THE PREFERRED EMBODIMENT

In the following description of preferred embodiments, reference is made to the accompanying drawings which form a part hereof, and in which it is shown by way of illustration specific embodiments in which the disclosure may be practiced. It is to be understood that other embodiments may be utilized and structural changes may be made without departing from the scope of the preferred embodiments of the present disclosure.

The present disclosure is directed toward a system and method for providing waste classification. In one embodiment, the present disclosure provides a system and method for handling hazardous materials events of various forms and at various locations. As used herein, the term hazardous material can include any material, whether solid, liquid or gaseous, that might cause harm, is believed to cause harm, or might be suspected to cause harm, to the environment or to humans or other living organisms, regardless of how slight such harm may be, and regardless of the extent to which a causal link between a harm and the material has been established. Hazardous materials can include, for example, materials that may be flammable or explosive; materials that may be irritating or damaging to the skin, lungs or other parts of the body; materials that may be harmful or damaging to the environment; radioactive materials; carcinogens; and materials that may be considered asphyxiates, and allergens.

Before describing the disclosure in detail, it is useful to describe a few example environments with which the disclosure can be implemented. One such example is that of a retail outlet that stores various forms of hazardous material for resale to other businesses or to the public. Another example is a warehouse or other like facility used to store hazardous materials either as part of the distribution chain, or as a staging facility or for some other purpose. In these example environments, workers at the facilities may be tasked with handling the materials at various stages. For example, workers may be asked to shelve products for retail sale, assist customers with purchases of products, inventory on-hand products, fill product orders, transfer products from one shipment vessel to another, and other like activities. While these workers handle the materials on a regular basis, they may not always have the training or other specialized knowledge needed to safely handle the materials in accordance with regulations, especially, for example, in the event of a spill or other non-routine event. Another example environment is that of a materials production facility where one or more hazardous materials are manufactured either for internal use or for sale. Yet another example environment is that of a factory or business that uses hazardous materials in the conduct of its business. For example, an automobile repair facility may use petroleum products such as gasoline, diesel fuel and oil, antifreeze, asbestos, paint, aerosols, and other chemicals and materials.

Embodiments of the invention are described herein in the context of one practical application, namely, classification of waste material. In this context, the example system is applicable to provide ready access to information on waste material. Embodiments of the invention, however, are not limited to such waste material applications, and the methods described herein may also be utilized in other applications. One such example is that of an accidental spill or release of a hazardous material. In addressing this spill, the facility at which the spill occurred would benefit from information regarding response activities including, for example, techniques and processes for cleaning up the spill, methods for treating the environment in which the spill occurred, proper packaging and labeling of the spilled materials, maintaining accurate records regarding the spill and the various data associated with the spill, and coordinating safe and proper removal and disposal of the spilled materials. Another example event is that of cleanup of a hazardous material in accordance with good safety practices as well as any applicable federal state and local rules and regulations. These examples are referred to from time to time herein when describing the invention and its various features and functionality. As would be apparent to one of ordinary skill in the art after reading this description, these are merely examples and the invention is not limited to operating in accordance with these examples.

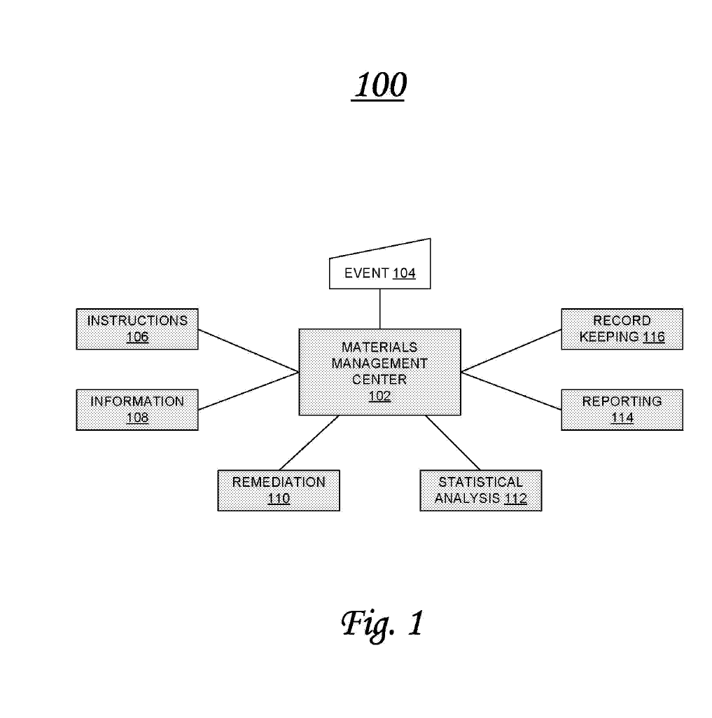

FIG. 1 is a block diagram illustrating an example overview of a materials management system 100. Materials management system 100 includes a materials management center 102 that can be implemented to function as the operational engine for the materials management system 100. Materials management center 102 can be a centralized facility, or any or all of its various functions can be distributed across a plurality of facilities or locations in a geographically diverse manner. Further, the various functions described herein as attributable to materials management center 102 can be distributed to and among the various facilities it services.

Materials management center 102 preferably includes one or more computers, servers, workstations, or other device for data gathering, processing, computing and reporting. Preferably, materials management center 102 also includes databases or other, data storage, record keeping and retrieval capabilities. Additional details regarding example implementations of a materials management center 102 in accordance with one or more embodiments of the present invention are described in greater detail below.

In operation, materials management system 100 receives an event 104 from a facility or other location that it is servicing. Events 104 can include information pertaining to a material or pertaining to an activity associated with a material at the requesting facility. For example, an event 104 can include information that a particular material is being readied for transit, that a particular hazardous material has been spilled or accidentally released, that a particular material is about to be applied or used in a given application, that a particular material is ready for disposal, or any other event associated with a material. In one embodiment, events 104 deal with materials that may have particular handling, transit, cleanup, disposal, storage or other requirements such as, for example, hazardous materials.

To facilitate a more detailed description of the invention and its various facets, the invention is described herein in terms of a few specific example events 104. After reading this description, it will become apparent to one of ordinary skill in the art how to implement the invention and several of its embodiments and features in responding to handling or otherwise managing any of a plurality of other materials-related events. One such example is that of an accidental spill or release of a hazardous material. In addressing this spill, the facility at which the spill occurred would benefit from information regarding response activities including, for example, techniques and processes for cleaning up the spill, methods for treating the environment in which the spill occurred, proper packaging and labeling of the spilled materials, maintaining accurate records regarding the spill and the various data associated with the spill, and coordinating safe and proper removal and disposal of the spilled materials.

Another example event is that of readying a hazardous material for usage or for shipment in accordance with good safety practices as well as any application federal state and local rules and regulations. These examples are referred to from time to time herein when describing the invention and its various features and functionality. As would be apparent to one of ordinary skill in the art after reading this description, these are merely examples and the invention is not limiting to operating in accordance with these examples.

Additionally, as a further example, events 104 can be automatically generated based on accumulated data such as data accumulated for a given facility. As an example of this, data gathered at a particular facility may provide a cumulative total of spilled materials since the last removal event. When the total (e.g., the amount of hazardous waste on hand) for a given material, class of materials, etc. reaches a determined threshold, an event can be generated to schedule removal and disposal of the accumulated materials.

Upon receipt of an event 104 (for example, notification that a particular material was spilled at a service facility), materials management center 102 queries the appropriate databases and records to determine information about the material and the proper handling of the materials so that appropriate responses can be generated. Additional information regarding the information obtained by materials management center 102 in responding to an event 104 is described below.

Upon gathering the appropriate information, materials management center 102 can generate the appropriate response which can include, for example, one or more of the following: instructions 106; information 108; remediation information 110; statistical analysis 112; reporting 114; and record keeping 116. The responses that can be generated by materials management center 102 are not limited to these responses but can include additional information, actions, and output as would be appropriate for the given application or environment.

Instructions 106 can include information such as, for example, specific information regarding the steps to follow in cleaning up the particular hazardous material that has been spilled, appropriate methods and techniques to store the spilled material, ways to treat the environment in which the material was spilled, methods for treating individuals that may have been exposed to the spilled material, and other like information and instructions. For example, if event 104 indicates that chlorine was spilled at a given facility, the instructions can include information to the facility such as to restrict access to the area until cleanup is completed, that the chlorine can be harmful if exposed to the skin and can also emit a poisonous gas, that the appropriate NIOSH/MSHA-approved full face positive pressure respirator and protective clothing should be worn (which can also be identified in the instructions), and that persons without suitable respiratory and body protection must leave the area. The instructions might also include information regarding the U.S. Department of Transportation (DOT), evacuation and transportation guidelines and the appropriate handling of containerized waste chlorine in accordance with applicable federal, state, and local health and environmental laws and regulations.

In another example where an event is not a spill of a hazardous material but instead the usage of a hazardous material, the instructions might include information on how to safely handle, use and dispose of a particular material. For example, information on whether effective ventilation should be provided, respiratory protection that should be used, eye and face protection that should be used, whether skin protection should be used, whether to avoid eating, drinking, and smoking in work areas, and so on.

Additionally, as yet another example, instructions can include special precautions for material handling and storage of the hazardous materials. For example, the information can include instructions on proper containers in which to store the material, appropriate temperature ranges for the environment in which the material is stored, incompatibility with other materials for storage, proper labeling for storage containers, shelf life or storage limits for the material, and other like information. As these few examples serve to illustrate, a variety of instructions and information can be provided to a requesting facility to provide them with the appropriate instructions for dealing with any of a number of different events 104.

Materials management center 102 can also generate information 108 in response to an event 104. Information 108 can include any information that may be relevant or pertinent to a material at a requesting facility. For example, information 108 can comprise a material safety data sheet (MSDS) or other like information for a material being handled at a requesting facility. Continuing with the previous examples of a hazardous material that has been spilled, information 108 might include, for example, a material safety data sheet for the spilled material, appropriate DOT regulations for the transportation of the material, federal, state, and local rules and regulations for dealing with the particular material, site-specific information or instructions regarding the material and its appropriate handling and any other information that may be useful or appropriate in the given circumstance.

Information and instructions in response to an event can be generated or come from data and records maintained by the materials management center. Additionally, such data can be obtained from third-party sources and other external instrumentalities. For example, where a worker may have been exposed to a hazardous material during an event, the system might retrieve information from a poison control center, and the system might patch the poison control center hotline directly to the site reporting the event.

Another response that can be provided by a materials management center 102 can include a remediation response 110. A remediation response 110 can be identification, triggering, or scheduling a remediation activity such as, for example, site inspections, materials removal, materials disposal, inventory updates, equipment or facility replacements and overhauls, and other like activities. Remediation 110 can be in response to an externally or internally generated event 104. For example, where a hazardous material has been spilled, materials management center 102 can also coordinate an appropriate remediation step such as scheduling an outside vendor to conduct the cleanup activities. In another example, where a hazardous waste material is on hand, materials management center 102 can also coordinate an appropriate remediation step such as scheduling an outside vendor to transport the accumulated materials to an appropriate disposal facility.

Thus, in addition to or instead of providing instructions 106 and information 108, materials management center 102 can coordinate the remediation activities with the facility or with a third party vendor or other service provider. In one embodiment, materials management center 102 can include a list of approved service providers for particular materials or classes of materials. Materials management center 102 can also include a list of approved service providers for particular facilities that are being serviced. With the information maintained electronically, scheduling of remediation activities can occur automatically in response to an event 104. As the examples above illustrate, remediation 110 can include transportation and disposal of hazardous materials as well as cleanup activities. Materials management center 102 can automatically schedule transportation and disposal activities with approved or certified vendors, and can send messages or other alerts to appropriate individuals that such events are ready to be scheduled.

For example, the spill of a particular material or class of materials may require immediate cleanup. In the event of such an occurrence, materials management center 102 can automatically schedule the cleanup activity and provide the appropriate notices to responsible individuals. As another example, materials management center 102 can schedule periodic or routine transportation and disposal activities such as those that occur on a regularly scheduled basis. As yet a further example, materials management center 102 can schedule transportation and disposal activities in response to a threshold or other like event. To elaborate, materials management center 102 may in one embodiment track the amounts of material accumulating at a particular facility. This system may be further configured such that when the amounts of material reach a certain threshold, transportation and disposal activities are automatically scheduled to remove the subject materials.

Materials management center 102 can also be configured to gather and to store the data and other information regarding events 104, service facilities, materials managed by the system, various rules and regulations, and other information, as illustrated by record keeping box 116. This information can be used for reporting purposes 114, historical record keeping 116, and statistical analysis 112. Various reports and other output data can be generated as an output of materials management center 102. For example, materials management center 102 can provide routine periodic reporting to the various service facilities for various purposes. As a more specific example of this, quarterly (or other period) status reports, summary reports, detailed reports or other reports outlining some or all of the information associated with the various events 104 can be generated and provided to the service facilities. In addition, as another example, periodic and event driven reporting necessary for government compliance can also be performed by materials management center 102 in an automated fashion. Data and other information gathered during the event handling process can be catalogued for later recall in relational or other databases. This data can be pulled and compiled into reports and other information necessary to comply with various federal, state, and local reporting requirements. As these few specific examples illustrate, automated or semi-automated reporting for various purposes can be managed and effectuated by materials management center 102.

In addition to reporting 114, statistical analysis 112 can also be performed by materials management center 102 using the data gathered. Event information as well as other materials and information can be analyzed on a statistical basis and reports generated outlining the results thereof. Trend analysis, performance analysis, troubleshooting, facility analysis, material analysis, and other statistical analysis can be performed automatically or in response to user requests. As one example, data pertaining to particular events 104 might be correlated to a particular shift or particular worker at a given facility, or might be correlated to a particular type of packaging used for the subject materials. As such, in this example, remedial measures might be taken to change the packaging, update handling instructions for the packaging and so on. The results of the statistical analysis can be included with the reporting function.

Although the events described above in the examples provided refer to external events generated at a requesting facility, events 104 can be generated at any of a number of external locations or can be internally generated based on various factors. For example, events 104 can be generated externally or internally as a function of time or periodic events such as regular reporting requirements, routinely-scheduled inventory events, routinely-scheduled removal and disposal events, and so on.

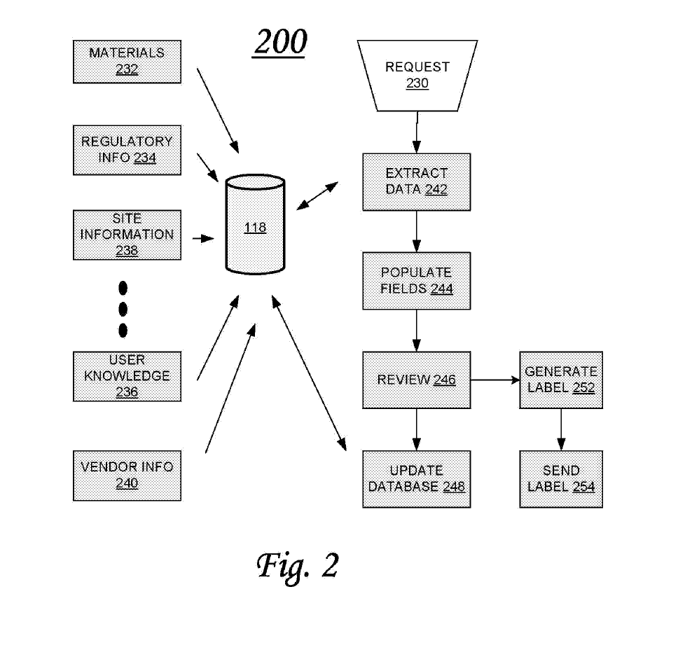

FIG. 2 is a diagram illustrating an example process 200 for responding to an example event in accordance with one embodiment of the invention. As discussed above, one feature that can be provided with a materials management system 100 in accordance with the present invention is the automated or semi-automated generation of hazardous materials information 108 in response to an event 104. One such form of information is a label that can be used for storage of hazardous materials. The example illustrated in FIG. 2 is an example of providing a hazardous materials storage label in response to a spill of a hazardous material.

A request 230 is received from a facility that is handling hazardous materials, which is herein referred to as a requesting facility. In the current example, the request 230 indicates that a particular hazardous material (or materials) has been spilled at the requesting facility. In one embodiment, the request 230 includes sufficient information to allow materials management center 102 to generate a label for the spilled hazardous material. For example, the request 230 can include information such as the identification of the requesting facility, an identification of the person making or responsible for the request, an identification of the material or materials spilled, and other information that may be useful in responding to the event.

For example, in one embodiment, the materials can be identified by a uniform or Universal Product Code (UPC) or other product identifier to provide some level of standardization across the various service sites. The product identifier can be used as a key or other identifier to provide additional information about the product such as, for example, the specific material involved, the manufacturer, the unit package size, and so on. As another example, the requesting facility identification may be used to identify not only the facility itself, but also to identify the location of the facility (which may be useful in determining which regulations to apply), facility specific handling requirements, designated points of contact and responsible parties and so on.

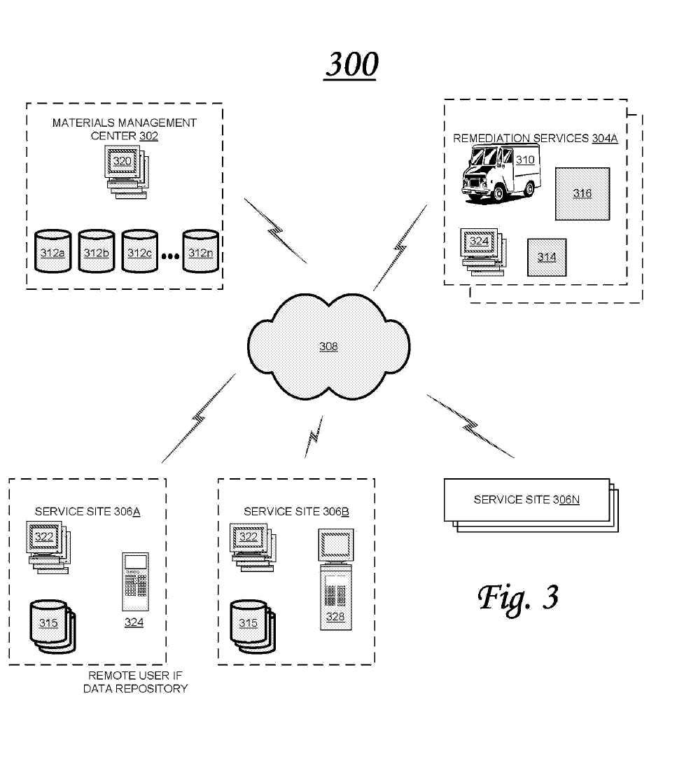

Request 230 can be received via a number of different communication mechanisms including, for example, telephone, fax, and postal service, as well as electronic messaging such as, for example, electronic mail, text message, file transfer, or any other suitable delivery mechanism. As described below with reference to FIG. 3, the various components of materials management system 102 can communicate via any of a number of various communications channels and mechanism.

Once the request 230 is received, materials management center 102 extracts the data and other information that will be used to create the requested label (task 242). This information can also be used to create the appropriate data record or data records used to maintain an appropriate history of the event for reporting and statistical purposes. For example, materials management center 102 may use the product identifier to obtain more information about the material spilled. As a more specific example, consider a case where the spilled material is a particular fertilizer. In this example, the UPC code may be used to retrieve information that the spilled material is a controlled release 15-9-12 fertilizer manufactured by the ABC fertilizer company and packaged in a twenty pound plastic bag. A UPC may also be used to retrieve information contained on the material safety data sheet for that product in either electronic or machine readable form. As this example illustrates, in this embodiment using the UPC or other product identification, a substantial amount of information 232 about the spilled material can be retrieved to assist in the creation of a label or to otherwise provide information useful for responding to the spill. As an alternative to using a UPC as a key to retrieve information, any or all of the required information can be included in the request from the requesting facility.

In response to the request 230, materials management center 102 can also extract regulatory information 234 to be used in generating the label. For example, regulatory information 234 can include state, federal, and local regulations outlining procedures and practices for handling the material spilled. In one embodiment, the UPC or other product identifier can be used to extract the appropriate set of regulatory information 234 that pertains to that particular product or to that class of products. For example, in the case of the 15-9-12 controlled release fertilizer described above, materials management center 102 may determine that there are particular federal, state, and local regulations dealing with the cleanup and transportation of the product as well as for the disposal of the product in an approved land fill disposal facility.

Materials management center 102 can also extract site specific information 238 that may exist relevant to the particular service site 238 or class of service site 238 that is making the request. For example, the service site may have particular clean-up, handling, or other requirements used to address materials handling events. As another example, the location of the site may dictate particular local regulations that apply. As still another example, site specific information may dictate the form of the response (e.g., fax, email, etc.), to whom the response is sent, and so on. In one embodiment, the site identification information included with request 230 can be used as a key to retrieve the site specific information 238 used in generating the response to the request.

Although the majority of the information used to generate a label and other material handling instructions is gathered and accumulated in an automated fashion in one embodiment, it is contemplated that there are instances where user knowledge may be used to supplement this information. For example, skilled users trained in handling various materials may be available to provide expertise and guidance in dealing with the particular material that is spilled (or in responding to another type of event). As such, user knowledge 236 can be provided as a component of information that is used in responding to request 230. For example, user knowledge may be entered by an operator via a keyboard or other user input device. The user knowledge may supplement the label, may provide additional handling instructions or other information to the facility, may be used to annotate the historical record, and so on.

Depending on the configuration, the system can also retrieve additional information such as, for example, remediation services information. In one example, various affiliated, internal and third-party vendors and their capabilities can be included in the database to allow the system to identify and even schedule an appropriate vendor for handling the given event. For example, in the event of a spill of a particular material, one or more vendors identified as being certified or approved for handling such spills (for example, cleanup, transportation and disposal) can be identified in the database and their information 240 retrieved in response to the request 230. Thus, contact and other information for these one or more vendors can be included in the response to the request. Additionally, in one embodiment, the system can automatically schedule a vendor from the approved vendor list to conduct remediation or removal activities. As a further example, a service site 238 may identify a preferred vendor or a group of preferred vendors for various services. As such, when that service site 238 is identified in a request 230, information regarding that particular service site's preferred vendors can be retrieved from the database.

The appropriate information is then extracted from the various data repositories; information used to respond to the request 230 is populated in various fields (task 244). For example, in one embodiment, one or more display screens are provided to an operator and include the extracted information. This information can be reviewed by the user for accuracy and completeness. Additionally, the user can update, edit, or add additional information that may be useful or necessary in responding to the request.

The materials management center 102 can update one or more databases to maintain a record of the events that transpired (task 248). For example, information pertaining to the date and time of the event, the facility at which the event occurred and its location, an identification of the material or materials involved, quantities of materials involved, actions recommended and taken, event closure and other such information can be recorded in the database for record keeping, reporting, and statistical analysis purposes.

With the information complete, an appropriate label is generated and includes information retrieved in response to the request (task 252). The label is sent to the requesting service site 238 to complete the response to the request (task 254). As stated above, the label can be sent by any of a number of transmission means including facsimile, e-mail, electronic messaging, file transfer, postal delivery, or any other communication mechanism. The label can then be affixed to the bin or other container housing the spilled materials in accordance with applicable regulations.

FIG. 3 is a block diagram illustrating an exemplary overview of a materials management system 300 in accordance with one embodiment of the present disclosure. In this example, materials management system 300 may include a materials management center 302, remediation services 304, and service site 306. Various elements 302/304/306 of the materials management system 300 may communicate via communications network 308.

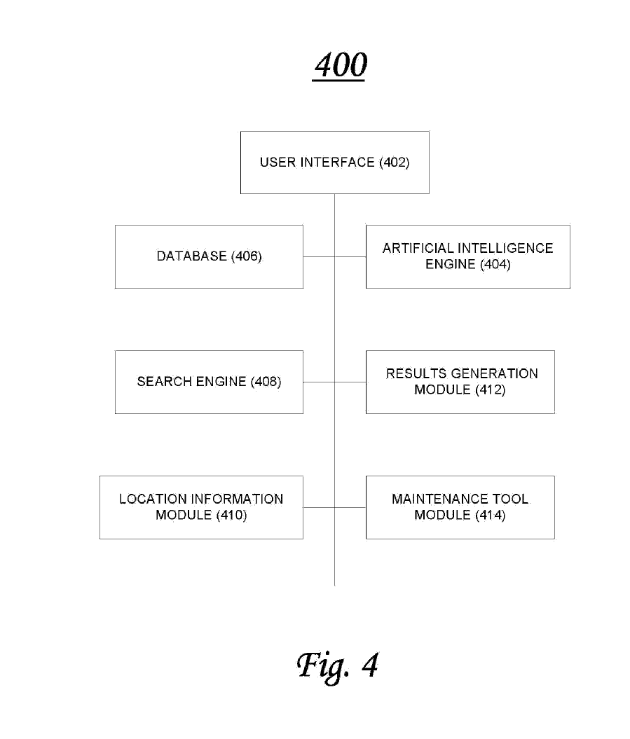

The materials management center 302 may be implemented to function as the operational engine for the materials event management system 300. As mentioned above, materials management center 302 can be a centralized facility, or any or all of its various functions can be distributed across a plurality of facilities or locations in a geographically diverse manner. Further, the various functions described herein as attributable to materials management center 302 can be distributed to and among the various facilities it services. Materials management center 302 preferably includes one or more computers, servers, workstations, or other data gathering, processing, computing and reporting. Preferably, materials management center 302 also includes databases or other, data storages, record keeping and retrieval capabilities. Additional details regarding example implementations of a materials management center 302 in accordance with one or more embodiments of the present invention are described in greater detail below. The exemplary embodiment of materials management center 302 is illustrated as including one or more computers or work stations 320 to facilitate operation thereof. Materials management center 102 can also include one or more databases 312a, 312b, 312c to 312n (where n represents total number of databases) to store the various data, including data pertaining to a plurality of waste classification as explained in more detail in the context of FIG. 4 below, and other information used in the materials management process. As the above examples illustrate, data can be maintained relating to federal, state, and local rules and regulations governing material handling (including shipment, storage, usage and disposal), material data and information, client specific information and other information used in the process of managing the various materials. Although separate database units are illustrated, data storage can be across any physical or logical data storage architecture, and any of a number of database models can be implemented. In one embodiment, a relational database structure is used to facilitate creation of responses from various separate sources of data.

As stated above, materials management center 302, whether centralized or distributed, can in one embodiment provide materials management functionality to a plurality of service sites 306 in geographically diverse locations. The example illustrated in FIG. 1 depicts service sites 306A, 306B to 306N (where N represents total number of service sites) illustrating that multiple service sites 306 of different types and configurations can be serviced by the material management center 302 in one embodiment.

Materials management center 302 can also generate information in response to an event. Information can include any information that may be relevant or pertinent to a material at a requesting facility. For example, information can comprise a material safety data sheet (MSDS) or other like information for a material being handled at a requesting facility. Continuing with the previous examples of a hazardous material that has been spilled, information might include, for example, a material safety data sheet for the spilled material, appropriate DOT regulations for the transportation of the material, federal, state, and local rules and regulations for dealing with the particular material, site-specific information or instructions regarding the material and its appropriate handling and any other information that may be useful or appropriate in the given circumstance.

Materials management center 302 can also be configured to gather and to store the data and other information regarding events, service facilities, materials managed by the system, various rules and regulations, and other information. This information can be used for reporting purposes, historical record keeping, and statistical analysis. Various reports and other output data can be generated as an output of materials management center 302. For example, materials management center 302 can provide routine periodic reporting to the various service facilities for various purposes. As a more specific example of this, quarterly (or other period) status reports, summary reports, detailed reports or other reports outlining some or all of the information associated with the various events can be generated and provided to the service facilities. In addition, as another example, periodic and event driven reporting necessary for government compliance can also be performed by materials management center in an automated fashion. Data and other information gathered during the event handling process can be catalogued for later recall in relational or other databases. This data can be pulled and compiled into reports and other information necessary to comply with various federal, state, and local reporting requirements. As these few specific examples illustrate, automated or semi-automated reporting for various purposes can be managed and effectuated by materials management center 302.

As mentioned above, in addition to reporting, statistical analysis can also be performed by materials management center 302 using the data gathered. Event information as well as other materials and information can be analyzed on a statistical basis and reports generated outlining the results thereof. Trend analysis, performance analysis, troubleshooting, facility analysis, material analysis, and other statistical analysis can be performed automatically or in response to user requests. As one example, data pertaining to particular events might be correlated to a particular shift or particular worker at a given facility, or might be correlated to a particular type of packaging used for the subject materials. As such, in this example, remedial measures might be taken to change the packaging, update handling instructions for the packaging and so on. The results of the statistical analysis can be included with the reporting function.

Although the events described above in the examples provided refer to external events generated at a requesting facility, events can be generated at any of a number of external locations or can be internally generated based on various factors. For example, events can be generated internally or externally as a function of time—for example, periodic events such as regular reporting requirements, routinely-scheduled inventory events, routinely-scheduled removal and disposal events, and so on.

In one embodiment, materials management center 302 is implemented to provide a centralized management center for providing materials management services, features and functions. In alternative embodiments, the services, features and functions provided by materials management center 302 as described herein can be distributed across a plurality of various facilities or locations as would be apparent to one of ordinary skill in the art after reading this description.

As stated above, in one embodiment, materials management center 302 is configured to provide various facilities with an appropriate response upon the occurrence of one or more events. Examples of a few possible configurations for such requesting facilities are provided and referred to as service sites 306 in FIG. 3. Examples of specific types of service sites 306 can include materials manufacturing plants, shipping and transportation companies, warehouses, retail facilities, factories, and so on. As such, in various embodiments of the invention, materials management center 302 or other like mechanism can be provided to perform a variety of materials management functions in support of these various service sites. For example, a retail store, automobile service facility, warehouse, or other service site 306 may handle various forms of hazardous materials on a daily basis, yet it may not be practical for such a service site 306 to itself maintain the knowledge and other skill sets necessary to properly handle the materials it deals with on a daily basis. As such, materials management center 302 in communication with one or more service sites 306 can provide the services, instructions, information, reporting, and other responses that service sites 306 may use, exclusively or as a complement to their own capabilities, to properly handle hazardous materials in the course of their business.

Remediation service 304 may include transportation and disposal services that can be used to remove hazardous waste from a requesting facility, transport hazardous materials from one location to another, and otherwise provide materials transportation services. An additional example of a remediation service 304 is a cleanup service. These and other remediation services 304 can be managed by materials management system 300. More particularly, in one embodiment, they can be managed and scheduled utilizing materials management center 302. As described above, in one embodiment the scheduling of such resources can be performed automatically by materials management center 302 in response to various threshold monitors and triggering events.

In one embodiment, where remediation services 304 are provided by outside vendors, an approval or certification process can be implemented to ensure that appropriate services are provided for a given event. For various vendors, various levels of certification may be available when approving vendors for certain of the provided services. For example, government licenses, government and private-party certifications, service site 306 approval, and materials-management-system certifications, to name a few, can be required to qualify or certify particular vendors.

As a further example, vendors may be required to have certain levels of experience, particular training and expertise, particular equipment and materials, in-depth knowledge the workings of materials management system 300 (at least as it relates to the vendor), the ability to properly tie into the system to share data, and other levels of skill, training, and experience. Thus, a given level of performance, experience and expertise can be required from the various remediation service providers to be approved by the system. In addition to levels of certification, various vendors may be placed on lists for various service facilities. For example, a particular service facility may maintain a list of its own vendors that it prefers to deal with for particular services or functions. In one embodiment, services sites 306 are provided with the ability to maintain and update their own vendor service provider lists for various services and functions such that materials management center 302 can schedule remediation resources based on approved vendors. Vendors and the various lists can be ranked in order of preference as well to enable prioritization of the choice of vendors.

Remediation services 304 can also be provided with remote user interfaces. Remediation services 304 can also be provided with certain access to kiosks at service sites 306, their own computer interfaces, or otherwise access to the IT infrastructure of materials management system 300. The level of access may be appropriately restricted to allow the remediation services 304 to have the ability to obtain, edit, and create only that information used for scheduling, performing and reporting the service. In other embodiments, remediation services 304 can be granted full access to the system or other partial access as may be deemed appropriate for the particular service provider or for the event to which they are responding. Thus, in this way, remediation services 304 can operate as an integral part of materials management system 300.

For example, service requests to a remediation services 304 provider can be provided electronically via e-mail, text messaging, electronic messaging, or other electronic means to provide scheduling requests to a desired service provider (although other communication mechanisms can be provided as well). Service requests can include detailed information about the service to be performed such as, for example, a service location (for example, at a requesting facility) the type of services to be performed, the materials involved, and a schedule for completing the services.

To better illustrate this point, consider an example where a remediation services provider is called to remove a plurality of hazardous waste materials from a particular service site 306. In making the request, materials management center 302 can provide a copy of the request to the desired remediation services 304 provider as well as to appropriate personnel at the affected service site 306. In this example, the request can also include a complete listing of materials that the vendor is to pick up at the service site 306 for removal and disposal. Thus, the service provider's schedule and shipping manifest along with other pertinent information can be provided electronically along with the request.

The contracted service provider can accept the request to confirm the appointment. Upon arrival at the designated service site 306, the vendor can log the materials that he or she actually receives for transportation and disposal. For example, a portable device such as a remote user interface 324 can be used by the remediation service 304 provider to scan in each item that is picked up for removal, although manual or other automated means can also be used to log materials. As the items are scanned in, or otherwise entered at the kiosk, remote user interface, or other terminal, the items verified as picked up for transport can be cross checked against the inventory list, manifest, or other data to ensure that there is correlation between the requested task and that which actually occurs. Similar logging and checking functions can occur at the disposal site as well. As such, with electronic entry and monitoring of the transportation and disposal process the system can track whether each of the items have been properly handled and accounted for. This information can be used in the recordkeeping, statistical analysis, and report generation functions to facilitate and enhance the functionality of the system.

Information and instructions in response to an event can be generated or come from data and records maintained by the materials management center. Additionally, such data can be obtained from third-party sources and other external instrumentalities. For example, where a worker may have been exposed to a hazardous material during an event, the system might retrieve information from a poison control center, and the system might patch the poison control center hotline directly to the site reporting the event.

Another response that can be provided by a materials management center 302 can include a remediation response. A remediation response can be identification, triggering, or scheduling a remediation activity such as, for example, site inspections, materials removal, materials disposal, inventory updates, equipment or facility replacements and overhauls, and other like activities. Remediation can be in response to an externally or internally generated event. For example, where a hazardous material has been spilled, materials management center 302 can also coordinate an appropriate remediation step such as scheduling an outside vendor to conduct the cleanup activities. In another example, where a hazardous waste material is on hand, materials management center 302 can also coordinate an appropriate remediation step such as scheduling an outside vendor to transport the accumulated materials to an appropriate disposal facility.

Thus, as mentioned above, in addition to or instead of providing instructions and information, materials management center 302 can coordinate the remediation activities with the facility or with a third party vendor or other service provider. In one embodiment, materials management center 302 can include a list of approved service providers for particular materials or classes of materials. Materials management center 102 can also include a list of approved service providers for particular facilities that are being serviced. With the information maintained electronically, scheduling of remediation activities can occur automatically in response to an event. As the examples above illustrate, remediation can include transportation and disposal of hazardous materials as well as cleanup activities. Materials management center 302 can automatically schedule transportation and disposal activities with approved or certified vendors, and can send messages or other alerts to appropriate individuals that such events are ready to be scheduled.

For example, the spill of a particular material or class of materials may require immediate cleanup. In the event of such an occurrence, materials management center 302 can automatically schedule the cleanup activity and provide the appropriate notices to responsible individuals. As another example, materials management center 302 can schedule periodic or routine transportation and disposal activities such as those that occur on a regularly scheduled basis. As yet a further example, materials management center 302 can schedule transportation and disposal activities in response to a threshold or other like event. To elaborate, materials management center 302 may in one embodiment track the amounts of material accumulating at a particular facility. This system may be further configured such that when the amounts of material reach a certain threshold, transportation and disposal activities are automatically scheduled to remove the subject materials.

Additionally, materials management system 300 can include one or more appropriate remediation services 304 to provide remediation supplies and services to the various service sites 306. For example, a hazardous materials transportation and disposal service 310 may be included to provide specialized transportation of hazardous materials in accordance with applicable rules and regulations. Such services can be provided by either independent operators, or operators who are somehow affiliated with materials management center 302, or one or more service sites 306, for example.

As discussed above, the appropriate response can include responses such as instructions regarding how to deal with the event, information pertaining to the event and the materials involved, scheduling or coordination of remediation and other activities and other like responses as described herein.

The service site 306 represents a subscriber to the materials management center 302. In the illustrated example, two particular service site 306 configurations are illustrated as service site 306A and service site 306B. Each of these example configurations are now described, although other service site 306 configurations are contemplated within the spirit and scope of the current invention.

To better describe a configuration of service site 306A it is useful to describe it in terms of a specific example. Consider the example where service site 306A is a retail establishment that sells various hazardous materials (for example, fertilizers, paints, cleaning supplies, and so on), maintains an inventory of such materials, and may even use such materials for its own purposes as well as for retail sale. Whether the retail establishment is a large national chain or a small, local mom-and-pop organization, most retail establishments include some form of computerization to assist in their retail sales operation.

Service site 306A is illustrated as including one or more computers or servers 322, one or more data repositories 315 and a remote user interface 324. For example, terminals at the loading dock may be used to enter information regarding materials received, while cash registers or other point of sale terminals may be used to monitor the sale of materials from inventory. Each of these systems can be connected to a computers 322 and data repository 315 to maintain an accurate record of materials inventory and other operations. Computers 322 and data bases 315 may be dedicated devices, configured to perform the materials management functions. In other environments, computers 322 and data bases 315 may be those used for other operations at the retail location that have been provided with the software or other capabilities to perform the materials management functions described herein. Various levels of integration between computers 322, databases 315 and other facility resources can be provided as may be desired to facilitate operations. For example, a closely integrated system may allow traditional systems such as cash registers to automatically feed information that may be used by materials management center 302 to track materials inventory.

The user at service site 306A can also enter additional information into remote user interface 324 or other interface. For example, the user may enter the type of event that is being registered. In the case of the current example, the user would identify that the material in question has been spilled and this would result in an event being generated being sent to materials management center 302 for an appropriate response. The event may be generated either automatically, or in response to further user input. Additionally, alerts or other messages can be sent to appropriate personnel in addition to or as a part of event.

In the illustrated embodiment, one or more remote user interface 324 can also be included to allow remote and portable access to service site 306 computers 322 as well as materials management center 302 (or other aspects of materials management system 300 from various locations in or near the service site 306A). For example, remote user interface 324 can be a bar code scanner, RFID tag reader, manual input device (touch screen, keypad, voice recognition, etc.), or other device that enables a user to input information pertaining to a material or materials being handled. Remote user interface 324 are not necessarily limited to hazardous materials management functions, but can also be used in the conduct of other facility operations. In one embodiment, portable terminals currently used by employees at retail establishments to check inventory, check prices, and perform other conventional tasks can also be used to facilitate materials management in accordance with the present invention.

To better illustrate the functionality that can be included with a remote user interface 324, consider an example where a material such as a fertilizer or other hazardous material is spilled within the retail sales facility. A worker at the retail outlet can use the remote user interface 324 to input information regarding the spill or to retrieve instructions and other information that may be useful in dealing with the spill. For example, the remote user interface 324 can be used to scan a bar code, RFID tag, or other product identifier to enable identification of the material in question. Alternatively, the user can key-in or otherwise manually enter information pertaining to the product that was spilled.

In one embodiment a UPC can be used to identify the product. In an implementation of this embodiment, the UPC can be used as a code to retrieve additional information about the product, regardless of whether such retrieval will be performed at the service site 306, at materials management center 302 or at some other location within or associated with materials management system 300.

Although two exemplary configurations for a service site 306 have been provided, these examples will serve to illustrate to one of ordinary skill in the art after reading this description that other configurations and architectures for service site 306 can be implemented to achieve the features and functions of the materials management system 300 as described herein. Additionally, the materials management system 300 can be implemented in such a way as to be scaled to handle a large number of various and diverse service sites 306.

The communications network 308 represents the communication methods employed in the materials management system 300. Although a single network cloud is depicted in FIG. 3, communications among the various elements of materials management system 100 can take place via any of a number of different communication channels or mechanisms, and are not necessarily confined to communication across a single local or wide area network. For example, communication elements such as the internet, the public switched telephone network (PSTN), other public and private networks, cellular links, satellite links, and other communication channels can be used alone or in various combinations to provide the elements of communications between and among the various components of materials management system 300. Thus, it is not necessary that all communication among the elements flow through a single communication network.

In one embodiment, remote user interface 324 can be implemented as a hand-held, battery operated device with a wireless interface allowing the user with flexibility and mobility of operation. In addition to wireless communications, a hard wired interface can be included including, for example, a docking station, cradle, or other like device to allow the remote user interface 324 to be charged as well as to transfer data to other components within the materials management system 300. A wired or wireless communication link between the remote user interface 324 and computers 322 can be provided to facilitate communication between the devices. Additionally, in one embodiment, a direct communication link between a remote user interface 324 and other elements of the materials management system 300 (including, for example, materials management center 302) can be provided as well.

The various elements of materials management system 300 may also include various communication components to enable communications among themselves as well as with outside entities. For example, communications interfaces to enable communication across network 308 or other communication channels between and among the various material management system components can be provided. The depicted example illustrates a communications interface implemented via a network 308.

FIG. 4 is an illustration of an exemplary waste classification system 400 that may be implemented at the materials management center 302 according to an exemplary embodiment of the present disclosure. In this example, the waste classification system 400 may include a user interface module 402, an intelligent waste classification module 404, a waste classification database module 406, a search engine module 408, a location information module 410, and a results generation module 412. The components work together to provide rapid response to classify waste materials. The waste classification system 400 may also include a maintenance tool module 414. In one embodiment, the system 400 is activated and provided as a web-based service to a user that accesses a web server at the management center 302. Various protocols for providing the web based services such as Simple Object Access Protocol (SOAP), Representational State Transfer (REST), and the like are known in the art.

The term “module” as used herein, refers to software, firmware, hardware, and any combination of these elements for performing the associated functions described herein. Additionally, for purpose of discussion, the various modules are described as discrete modules; however, as would be apparent one of skilled in the art, two or more modules may be combined to form a single module that performs the associated functions according the embodiments of the present disclosure.

The user interface module 402 provides a graphical user interface (GUI) configured to prompt a user for waste information pertaining to a material, and receive the material information from the user. The user interface module 402 may be provided to a user or an employee located at the management center 302 who is assisting a customer located at a service site 306. Alternatively, a user may be provided with access information to log onto the materials management center 302 from his or her home, from a service site 306 or from some other remote location via communication network 308 (e.g., Internet). Such access may be via numerous mechanisms such as a personal computer or laptop; a PDA, smartphone or other handheld computing device; a telephone; or other appropriate interface mechanism. As such, personnel may maintain contact with the system from various locations. For example, managers or other appropriate personnel from a service site 306 may be able to log on to the system to obtain waste classification information, generate needed or useful reports, review data, reports and statistics, and other like operations.

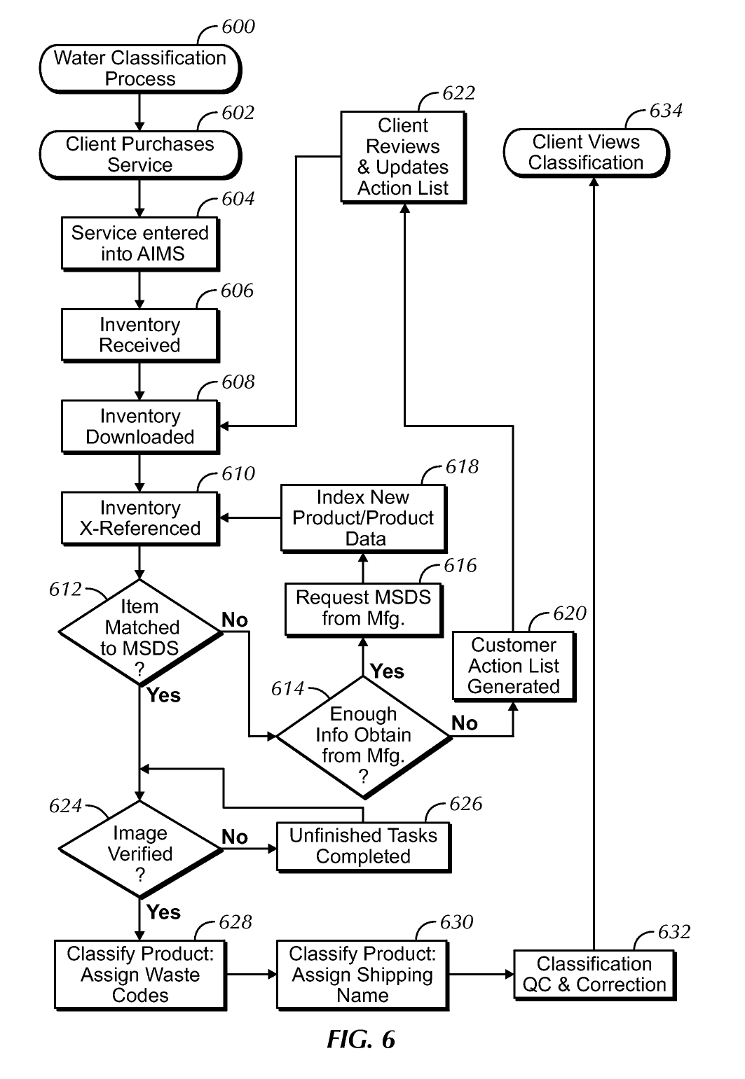

The system may also include an intelligent waste classification module 404 coupled to the user interface module 402 and the waste classification database module 406, configured to manage the waste classification database module 406 information. The intelligent waste classification module 404 leverages existing classifications for new customers, thus providing an interactively powerful and flexible method of obtaining waste classification information and obtaining complete and non-redundant data with greater accuracy of data collection and waste classification. An exemplary intelligent waste classification process according to an embodiment of this disclosure is explained in greater detail in the context of FIG. 6 below.

The waste classification database module 406 may be configured to store data pertaining to a plurality of waste classifications. In one embodiment, the waste classification database module 406 is based on a Microsoft Access application and database. In one alternative embodiment, the waste classification database module 406 is based on the Microsoft.Net framework and SQL2000 or SQL2005 databases, as an enterprise solution. The waste classification database module 406 may, for example, include entries such as federal, state and local rules that indicate how certain materials are handled, location of the waste, location of contractors handling the waste, hardware stores, transportation contractors for disposing the waste material, and the like.

The search engine module 408 may be configured to search the waste classification database module 406 to retrieve waste classification data corresponding to a material or product previously stored into a database module 406. If the material has been previously classified, the information for the previous classification automatically populates the inventory database or folder for the current customer. If the material or product has not been previously classified, it is classified and stored in the database module 406 for future automatic classification for new customers or products. As used herein, the term “product” generally refers to a material, item or product to be classified.

The location information module 410 may be configured to modify the waste classification data based on a location for the waste. For, example, federal state and/or local regulations may vary for a particular material depending on the geographic location, type of environment, and/or the type of facility where the material is located. In one embodiment, the location information module 410 comprises an integrated Global Information System (GIS). The GIS may be based upon the MICROSOFT MAPPOINT web service. The GIS provides dynamic searches for point-of-interest data within a specified radius of the release location. The point-of-interest data comprises hazardous material handling contractor locations, and/or comprises hazardous material handling regulations applicable at the location. The GIS provides dynamic searches for point of interest data (e.g., hazardous material handling contractor locations) within a specified radius of the release location.

A results generation module 412 coupled to the user interface module 402 and the waste classification database module 406, is configured to retrieve waste classification data from the waste classification database module 406 based on the material/inventory information by querying the waste classification database module 406 with the material/inventory information to receive the waste classification data. The results generation module 412 is further configured to generate a waste classification response based on the material/inventory information by presenting the waste classification data on the GUI 402.

The maintenance tool module 414 allows the user to update or modify the data and behavior of the waste classification database module 406, the search engine module 408, the intelligent waste classification module 404, and the location information module 410. For example, certain information for the user interface module 402 may be pre-populated depending on the availability of such information. For example, where a waste inquiry request is generated by an existing service facility, that facility's identification information may be pre-populated in the form. Additionally, where the waste is of a particular class of waste materials and information is known about that class of waste materials such information may also be pre-populated. Still further, where information is known about the waste material, but additional information may be required or desired, such known information may be pre-populated. The user can review the pre-populated information via the maintenance tool module 414 and make any edits or adjustments as necessary and fill in any additional information that is necessary or useful to complete the request. This information can be provided based on the user's knowledge and experience in the field and in dealing with particular waste materials. Additionally, links and other access to internal and external data repositories (e.g., federal, state, and local regulatory databases) can be provided to the user such that the user can perform any research that may be necessary or useful in completing the request.

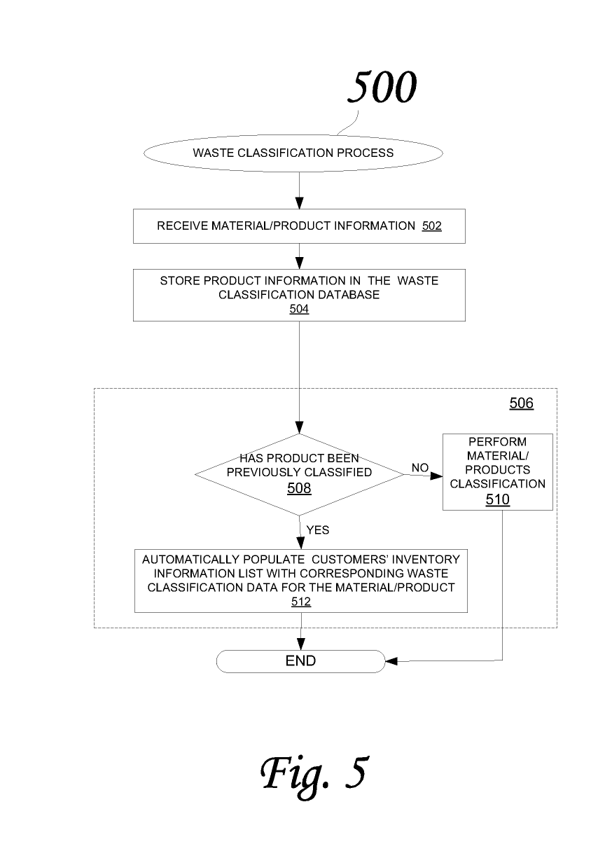

FIG. 5 is an illustration of an exemplary waste classification process according to an embodiment of the present disclosure. The process comprises receiving product or material information from a user, and searching the product or material waste classification database to perform classification of waste material. The various tasks performed in connection with the waste classification process 500 may be performed by software, hardware, firmware, or any combination thereof. It should be appreciated that process 500 may include any number of additional or alternative tasks, the tasks shown in FIG. 5 need not be performed in the illustrated order, and the waste classification process 500 may be incorporated into a more comprehensive procedure or process having additional functionality not described in detail herein. For illustrative purposes, the following description of the waste classification process 500 may refer to elements mentioned above in connection with FIGS. 1-4. In various embodiments, portions of the waste classification process 500 may be performed by different elements of systems 100-400, e.g., a materials management center, remediation services, service sites with a centrally located or distributed automated hazardous materials event response management system including: the user interface module, the waste classification database module, the search engine module, the location information module, the response generation module, the intelligence waste classification module, and the maintenance tool module.

In one embodiment, the waste classification process 500 may begin by receiving product inventory information from a user (task 502). An operator or other service personnel (e.g., an employee, or other authorized personnel assisting a customer) can receive the call from the requesting service site 306 and utilize the user interface 402 to facilitate generation of the appropriate response. A user at a service site 306 may initiate a telephone call to a materials management center to report a new product being added to inventory, or a material spill. For example, these embodiments contemplate the use of conventional telephones, cellular telephones, satellite telephones, radio telephones or other telephonic instruments, including, smart phones and other electronic devices with telephonic capabilities. Alternatively, the request can also be received directly from a user via a GUI provided to the user (e.g., a customer at the service site). In this case, the user may access the GUI via, for example, a computer, and enter responses to prompts, for example, through a computer keyboard, a touch-screen keypad, or the like.

A request is received from a facility that is handling waste materials. For ease of discussion, this will be referred to as a requesting facility. In one example, the facility provides a list of items, materials or products to add to its inventory list maintained at the management center 302 for waste classification. For example, a GUI may prompt for information such as the identification of the requesting facility, an identification of the person making or responsible for the request, an identification of the new material or products, and other information that may be useful in waste classification.

In operation, systems 100-400 receive material or product information from a facility or other location that it is servicing. The material or product information can include information such as chemicals or ingredients contained in a particular product, or an MSDS code associated with the particular product, and the like. In one embodiment, the waste classification information can be based on an MSDS associated with each inventory item in a client's material inventory list. Depending on their classification various materials/products may have particular handling, transit, cleanup, disposal, storage or other requirements.

Process 500 may dynamically change the user interface prompts depending on the information received. For example, the system will first screen the information via a GUI to determine if the user (requesting facility) has a service account, and if the user is authorized to invoke the service. If neither is the case, a new account forms may be opened for the user to prompt the user, or the user may fail at this point and may be disconnected from the system.

For example, in one embodiment, it can be determined whether the user report is coming in from an authorized or recognized service site 306. If the user is not a recognized subscriber, a script or other response can be provided on the GUI to the user telling them they have no account or asking for additional information (for example, to key in subscriber or ID information). As another example, screening may indicate that the user has an out of date account or other information that requires updating. In this case, the user can be transferred to a customer service representative or otherwise rerouted to verify and update account information or scripts can be used for automated updating and verification. In one embodiment, a by-pass can be provided such that remedial action can be taken in event of emergencies, bypassing or putting off the update process.

After identification of the requestor is verified, the system can prompt the user to provide or confirm the facility and user identification. For example, the user or an employee may be prompted to enter identification code, PIN code or other identifier by a computer keypad. In one embodiment, an identification of the customer or the facility requesting the response can be made based on a facility ID or other information included in the request. For example, in Internet networked or other computer implemented environments, login information, an IP address, cookies or other computer or terminal identification techniques can be used to identify the requesting service site 106 and, in some implementations, the particular user initiating the request.

Based on the identification, in one embodiment, information can be captured including for example: the name, employee identification number or other identification of the person initiating the request; an identification of the service site 306 from which the request was received, which can include site specific as well as chain, franchise, or other like affiliated identification; a geographic location of the requesting site; contact information for the requesting person, the department involved with the event, or a service department of the service site. Responses may be returned, including for example, fax number, e-mail address, IP address, mailing address, or other information regarding return of an appropriate response.

Appropriate information extracted from the various data repositories used to respond to the request is populated in various fields. For example, in one embodiment, one or more display screens are provided to an operator, and include the extracted information. This information can be reviewed by the user for accuracy and completeness. Additionally, the user can update, edit, or add additional information that may be useful or necessary in responding to the request.

Upon receiving the product information from the user, the material management process 500 may then add the product information to the waste classification database (task 504), and search the waste classification database (task 506), wherein the waste classification database is intelligently managed to obtain complete and non-redundant waste classification data for the product (as explained in more detail in the context of FIG. 6 below). The search comprises determining whether the product has been previously classified (inquiry task 508). If the product has been previously classified (“Yes” branch of inquiry task 508) then process 500 automatically populates customer's inventory information list (e.g., datasheets) with corresponding waste classification data for the material/product (task 512). Otherwise (“No” branch of inquiry task 508), process 500 performs material classification (task 510) based on an MSDS attached to inventory items in a Client's material inventory (as explained in more detail in the context of FIG. 6 below).

In one exemplary embodiment, when an event (i.e., notification that a particular material was spilled at a service facility) occurs, materials management center 302 queries the appropriate databases (e.g., waste classification database) and records to determine information about the material and the proper handling of the materials so that appropriate responses can be generated. For example, according to an embodiment of this disclosure, the system can be configured to perform a look-up or other operation based on the product or material information to determine whether the waste material or product code exists in the waste classification database. If the information is not found, the system may prompt the user for additional information or to retry the entry. If the entry is still not found, the customer can be forwarded to customer service, or prompted for additional information. If however, the material or product is located in the waste classification database, the operation can continue. Additionally, if the information is located, the user can be asked to verify the identification of the material or product searched.

FIG. 6 shows a flow diagram of a waste classification process 600 according to an embodiment of the present disclosure. The various tasks performed in connection with process 600 may be performed by software, hardware, firmware, or any combination thereof. It should be appreciated that process 600 may include additional or alternative tasks, the tasks shown in FIG. 6 need not be performed in the illustrated order, and process 600 may be incorporated into a more comprehensive procedure or process having additional functionality not described in detail herein. For illustrative purposes, the following description of process 600 may refer to elements mentioned above in connection with FIGS. 1-4. In various embodiments, portions of process 600 may be performed by different elements of systems 100-400 (e.g., a materials management center, remediation services, service sites with a centrally located or distributed automated materials management system including: the user interface module, the waste classification database module, the search engine module, the location information module, the response generation module, the intelligent waste classification module, and the maintenance tool module).

A waste classification process 600 may begin by a customer purchasing service (task 602). An operator or other service personnel (e.g., an employee who is assisting the customer) can receive a call from the requesting service site 306 (e.g., customer) and utilize the user interface to input a query for information. A user (e.g., a customer) at a service site 306 may initiate a telephone call to a materials management center to check the classification of a waste material. These embodiments, as explained above, contemplate the use of conventional telephones, cellular telephones, satellite telephones, radio telephones or other telephonic instruments, including PDAs, smart phones and other electronic devices with telephonic capabilities. Alternatively, the request could also be directly received from a customer (e.g., a user at the service site) via the Internet or other computer network. In this case, the user (e.g., customer) may be provided a GUI via, for example, a computer, and enter responses to prompts, for example, through a computer keyboard, a touch-screen keypad, or the like. The service is then entered into an account information management system (AIMS) (task 604).

When inventory is received from the customer (task 606), the inventory is downloaded (task 608) into the materials management system 300. As mentioned in the context of FIG. 5 above, in one embodiment, the product or inventory information from a user is added to a waste classification database module 406. The waste classification database module 406 is intelligently managed via the intelligent waste classification module 404 to obtain complete and non-redundant data by comparing the product information from the user (downloaded data) to the data existing in the waste classification database module 406 for the current and other customers. The intelligent waste classification module 404 reuses existing waste classification items and/or updates and/or adds data to existing waste classification items. Furthermore, the system leverages existing classifications for new customers. For example, if there are five customers using the same waste product, the system may need to store the waste product classification only once.

Then, a specific inventory item “X” may be referenced or selected (task 610) by the customer. Reference to the inventory item “X” may be done as part of the set up, operation, or maintenance of the customer waste classification database. Then, the inventory item “X” is matched to a material safety data sheet (MSDS) (inquiry task 612). If there is no match of the inventory item “X” to the MSDS (“No” branch in inquiry task 612), then a check is made if enough information has been obtained from the manufacturing operation, for example, that produces the waste material (task 614). If there is sufficient information obtained from the manufacturing (“Yes” branch in inquiry task 614), then a request is made for an additional MSDS from manufacturing (task 616), and the new product and/or product data is indexed into the customer waste classification database (task 618) and, thereafter, process 600 returns to task 610. If there is not sufficient information obtained from manufacturing (“No” branch in inquiry task 614), then a customer action list is generated (task 620). The customer action list contains an accumulated list of all missing inventory items and/or a list of missing data needed for the MSDS. The customer then reviews and updates the action list (task 622), and a new inventory is downloaded from the customer (task 608). The customer may do the review and update action list online via the GUI in real time, or later, for example, after further inquiry into the classification from sources available to the user such as state and federal rule books.

If there is a match of the inventory item “X” to the MSDS (“Yes” branch in inquiry task 612), then a replica of the inventory item “X” from the waste classification database (i.e. a database image) is verified (inquiry task 624) for completeness. If the image is not complete (“No” branch in inquiry task 624), then any unfinished tasks are completed (task 626), and the image is re-verified (task 624). The unfinished tasks may include, for example, inaccurate data or empty data fields. If the image is complete (“Yes” branch in inquiry task 624), then the inventory item “X” (product) is classified by assigning waste codes (task 628), and a shipping name (task 630). The waste codes may be predefined codes such as UPC codes, or user (customer) defined codes. For example, the customer may design a particular code that has a predetermined meaning to that customer. The waste codes may alternatively or additionally be defined based on federal and state rules or guidelines and Department of Transportation coding rules. The classification is then checked for quality control and correction (task 632) and is provided to the customer. The customer can them view the classification (task 634) as needed via the GUI interface or other communication such as, but not limited to, email or fax.

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described, but instead can be applied, alone or in some combination, to one or more of the other embodiments of the disclosure, whether or not such embodiments are described and whether or not such features are presented as being a part of a described embodiment. Thus the breadth and scope of the present disclosure should not be limited by any of the above-described exemplary embodiments.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to,” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

Although embodiments of the present disclosure are described herein in terms of hazardous materials, it should be understood that the present disclosure is not limited to hazardous materials, but is generally applicable to material handling. Furthermore, although the present disclosure has been fully described in connection with embodiments thereof with reference to the accompanying drawings, it is to be noted that various changes and modifications will become apparent to those skilled in the art. Such changes and modifications are to be understood as being included within the scope of the present disclosure as defined by the appended claims.

What is claimed is:

1. A waste classification system, comprising:
a user interface module configured to receive product information pertaining to at least one product from a user;
a database module configured to store waste classification information for a plurality of products;
a waste classification module configured to determine whether waste classification data for the at least one product has been previously stored in the database module; and
a search engine module configured to search the database module for the waste classification data corresponding to the at least one product.

2. The waste classification system of claim 1, further comprising automatically populating a customer's inventory information list with the waste classification data corresponding to the at least one product, if the waste classification data for the at least one product has been previously stored in the database module.

3. The waste classification system of claim 1, further comprising prompting the user for additional information corresponding to the at least one product, if the waste classification data for the at least one product has not been previously stored in the database.

4. The waste classification system of claim 1, further comprising a location information module configured to modify the waste classification data based on a location of the at least one product.

5. The waste classification system of claim 1, wherein the user interface module is further configured to provide a graphical user interface (GUI) via a webpage through the Internet.

6. The waste classification system of claim 5, wherein the GUI is configured to:
prompt the user for login information of a customer, wherein the user comprises the customer or a member of service personnel who is assisting the customer; and
receive the login information of the customer from the user in response to the prompt.

7. The waste classification system of claim 6, further comprising populating the GUI with information pertaining to the customer in response to the login information of the customer.

8. A method for waste classification, the method comprising:
receiving information pertaining to at least one product from a user;
storing the information pertaining to the at least one product in a database;
determining whether waste classification data for the at least one product has been previously stored in the database; and
searching the database for the waste classification data corresponding to the at least one product.

9. The method of claim 8, further comprising automatically populating a customer's inventory information list with the waste classification data corresponding to the at least one product, if the at least one product has been previously classified.

10. The method of claim 8, further comprising:
prompting the user to obtain new waste classification data, if the at least one product has not been previously stored in the database; and
storing the new waste classification data in the database.

11. The method of claim 10, further comprising:
matching the information pertaining to the at least one product to a material safety data sheet; and
classifying the at least one product by assigning a waste code to the at least one product.

12. The method of claim 11, wherein the waste code comprises a predefined code such as a UPC code or user defined code.

13. The method of claim 8, further comprising screening the user for account information.

14. The method of claim 8, further comprising adjusting the waste classification data based on a location of the at least one product.

15. The method of claim 14, further comprising changing the waste classification data according to regulations applicable at the location of the at least one product.

16. The method of claim 8, further comprising updating the database according to new regulations.

17. The method of claim 8, further comprising:
prompting the user for login information of a customer; and
receiving the login information of the customer from the user, wherein the user comprises personnel of the customer.

18. The method of claim 17, further comprising populating a graphical user interface (GUI) with information pertaining to the customer in response to the login information of the customer.

19. A method for waste classification, the method comprising:
receiving information pertaining to at least one product from a user;
storing the information pertaining to at least one product in a database;
alerting the user, if the product has not been previously classified; and
automatically populating an inventory information list for a customer with the corresponding waste classification data, if the at least one product has been previously classified.

20. The method of claim 19, further comprising storing new waste classification data received from the user in the database, if the at least one product has not been previously stored in the database.

21. The method of claim 19, further comprising:
matching information pertaining to at least one product to a material safety data sheet; and
classifying the at least one product by assigning a waste code corresponding to the material safety data sheet.

22. The method of claim 21 wherein the waste code comprises a predefined code such as a UPC code, or a user defined code.

23. A method for waste classification, the method comprising:
receiving information pertaining to at least one product from a user;
determining whether the information pertaining to the at least one product matches to a material safety data sheet that has been previously stored in a database;
classifying the at least one product by assigning a waste code corresponding to the material safety data sheet to obtain waste classification data, if the information pertaining to the at least one product matches to the material safety data sheet; and
providing the user with the waste classification data pertaining to the at least one product.

24. The waste classification method of claim 23, further comprising:
entering a waste classification service for the user into an automated inventory management system;
storing the information pertaining to the at least one product into the database;
requesting new material safety data sheet from the user, if the information pertaining to the at least one product does not match to the material safety data sheet; and
storing the new material safety data sheet into the database.

25. The waste classification method of claim 23, further comprising:
providing the user with an action list to obtain new waste classification data pertaining to the at the least one product, if the at least one product has not been previously stored in the database, wherein the action list comprises a list of new products and corresponding material safety data sheets; and
storing the new waste classification data in the database.
